(19) United States
(12) Patent Application Publication
(10) Pub. No.: US 2025/0165587 A1
(43) Pub. Date: May 22, 2025

(54) PROTECTION METHOD AND PROTECTION SYSTEM FOR EXECUTABLE FILES AND SHARED LIBRARIES

(71) Applicant: QNAP Systems, Inc., New Taipei City (TW)

(72) Inventor: Chin-Hsing HSU, New Taipei City (TW)

(21) Appl. No.: 18/432,263

(22) Filed: Feb. 5, 2024

(30) Foreign Application Priority Data
Nov. 20, 2023 (TW) 112144797

(51) Int. Cl. G06F 21/54; G06F 21/60

(52) U.S. Cl. CPC G06F 21/54; G06F 21/602

(57) ABSTRACT

A protection method for executable files and shared libraries and a corresponding protection system are provided, which encrypt a part of contents of an executable file or a shared library, decrypt the part of contents in real time when the executable file or the shared library is executed, and prohibit the execution of the encrypted contents of the executable file or the shared library by a debugged process, so as to prevent attackers from obtaining the part of contents of the executable file or the shared library.

### BACKGROUND

### 1. Technical Field

The present disclosure relates to a technology for protecting executable files and shared libraries. The present disclosure further relates to a technology of anti-reverse engineering and anti-debugging for executable files and shared libraries.

### 2. Description of Related Art

Computer-executable software is usually packaged as an executable file or a shared library. The purpose of binary obfuscation of executable files or shared libraries is to increase the security of the software and prevent reverse engineering. With binary obfuscation, the execution logic of the software is more difficult to understand and analyze, which makes it difficult for an attacker to analyze and understand the inner operation of the program. This prevents intellectual property theft and hinders reverse engineering, or makes it difficult for attackers to find vulnerabilities to attack.

Currently, code reorganization and instruction replacement are two common methods of code obfuscation.

Code reorganization is a process of reorganizing the structure of binary codes to make it more difficult to understand. This may include changing the order of functions of a program, repositioning code blocks, inserting invalid instructions or useless code fragments in order to interfere with the analyst's understanding of the flow and logic of the codes of the program.

Instruction replacement is a process of replacing the original binary instructions to make the execution path and logic of the program more obscure and more difficult to understand. The replacement may be based on fixed conversion rules or dynamically generated rules. For example, replacing binary instructions with an equivalent but more complex sequence of instructions, or replacing the binary instructions with similar instructions, in order to make the behavior of the program more unpredictable.

These methods can be used in combination with other obfuscation techniques, such as instruction insertion, false control flow, invalid instructions, or data insertion. Mixing multiple techniques can make it more difficult for analysts to understand and parse binary codes to improve software security and resistance to reverse engineering.

Although code reorganization and instruction replacement are common methods for binary code obfuscation, they cannot completely prevent an attacker from analyzing a process in execution and suffer from the following drawbacks:

Firstly, increasing execution time and performance overhead: Obfuscation techniques often introduce additional computation and runtime processing, which may increase the execution time and performance overhead of a program. For example, code reorganization and instruction replacement may lead to additional computation at execution to restore the original flow and logic of the program, which may lead to performance degradation.

Secondly, increasing the cost of development and maintenance: Obfuscation of program codes may increase the complexity of development and maintenance. Obfuscation techniques may require special tools and processes to handle obfuscated codes. In addition, since the obfuscated codes may be difficult to understand, more efforts and time may be required in the process of development and maintenance.

Thirdly, reversibility: Most obfuscation techniques are reversible, which means that an attacker can restore the original program codes by reverse engineering. For example, code reorganization and instruction replacement can be reversely engineered by corresponding anti-obfuscation techniques to restore the original structure and logic of the program.

Fourthly, difficulty in the processing of pointers and data: Some obfuscation techniques may make the processing of pointers and data difficult. For example, instruction replacement may change the way pointers are used or data are manipulated, making the processing of pointers and data more difficult.

Fifthly, incomplete protection: Obfuscation techniques can increase the difficulty of analysis and reverse engineering, but they cannot provide absolute protection. With enough time and effort, it is still possible for an experienced attacker to decode or restore obfuscated codes. Obfuscation techniques should be used as part of a security strategy together with other defensive measures (such as encryption, integrity check, and authorization mechanism) to improve the overall security of software.

In view of the above, there is a need for more stringent protection techniques.

### SUMMARY

To address the above issues, the present disclosure provides a protection method for executable files and shared libraries, executed by at least one processor of an electronic device in an operating system of the electronic device. The protection method includes: determining, by the electronic device, whether a first process is being debugged or is formed by execution of a second executable file; if the first process is being debugged and is about to execute a first executable file that is encrypted, prohibiting the first process from executing the first executable file; if the first process is being debugged and is about to perform memory mapping on a shared library that is encrypted, prohibiting the first process from performing the memory mapping on the shared library; and if the first process is formed by the execution of the second executable file, and the second executable file is encrypted, and a second process is about to debug the first process, prohibiting the second process from debugging the first process.

In an embodiment, after the first process performs the memory mapping on the shared library, the protection method further includes: if the shared library is encrypted and the second process is about to debug the first process, prohibiting the second process from debugging the first process.

In an embodiment, if the first process is formed by the execution of the second executable file, the protection method further comprises: when executing the second executable file, determining whether the second executable file is encrypted according to a flag field of a header of the second executable file; if the second executable file is determined to be encrypted, setting a label in a security context pointed to a task structure of the first process; when the second process is about to perform the debugging of the first process, checking whether the label has been set in the security context of the first process; and if the label has been set in the security context, prohibiting the second process from performing the debugging of the first process.

The present disclosure also provides a computer-readable storage medium storing a plurality of instructions that are to be read by an electronic device to perform the protection method described above.

The present disclosure further provides a protection system for executable files and shared libraries, including: a storage device where an operating system is installed; and at least one processor configured for executing the operating system and executing the aforementioned protection method in the operating system.

The present disclosure protects executable files and shared libraries with techniques of anti-reverse engineering and anti-debugging to prevent attackers from obtaining decrypted contents in executable files and shared libraries through reverse engineering or debugging. In addition, the present disclosure is also applicable to executable files and shared libraries that have been processed through binary obfuscation.

### BRIEF DESCRIPTION OF THE DRAWINGS

The present disclosure can be more fully understood by reading the following descriptions of the embodiments, with reference made to the accompanying drawings.

FIG. 1 to FIG. 5 are flowcharts of a protection method of an embodiment of the present disclosure.

FIG. 6A, FIG. 6B and FIG. 7 are flowcharts of a protection method of another embodiment of the present disclosure.

FIG. 8 is a block diagram of a protection system of an embodiment of the present disclosure.

### DETAILED DESCRIPTION

The following examples are used for illustrating the present disclosure. A person skilled in the art can easily conceive the other advantages and effects of the present disclosure, based on the disclosure of the specification. The present disclosure can also be implemented or applied as described in different examples. It is possible to modify or alter the following examples for carrying out the present disclosure without contravening its spirit and scope, for different aspects and applications.

It is further noted that, as used in the present disclosure, the singular forms “a,” “an,” and “the” include plural referents unless expressly and unequivocally limited to one referent. The phrase “and/or” indicates that a plurality of features, elements, or components are to be taken individually, or some of the features, the elements, or the components are to be taken collectively.

The protection method of the present disclosure is applicable to the Linux operating system. Before describing the protection method of the present disclosure, the following technical details of the Linux operating system are described to facilitate the understanding of the protection method of the present disclosure.

### Executable File

An executable file is a computer file in binary format that includes compiled program codes and related resources that can be executed directly on a computer.

In software development, the program codes usually undergo a compilation process to convert high-level programming languages (e.g., C, C++, Java, etc.) into machine codes, which are binary instructions that can be executed directly by a processor. The compilation process includes steps such as syntax checking, semantic analysis, code generation and optimization, and finally generates one or more executable files.

The format and the structure of an executable file may vary according to the operating system and the execution environment. For example, the common format of executable files in Linux and UNIX operating systems is the Executable and Linkable Format (ELF), while the common format of executable files in the Windows operating system is the Portable Executable (PE) format.

### Shared Library

A shared library, also known as a dynamic link library (DLL), is a program library that can be shared by multiple executable files. It is a binary file that includes functions and resources needed by multiple executable files.

Common formats of shared libraries include the ELF format of the Linux and UNIX operating systems and the DLL format of the Windows operating system. A shared library may be provided by a developer, by an operating system, or by the third party, and can be used via a linker or dynamical linking when an executable file is in the running state.

### The ELF Format

The ELF file format is widely used for executable files, shared libraries, and object files in the Linux and UNIX operating systems. It defines the structure and the organization of files for loading, executing, and linking program codes in the operating system. The following are some of the main components of the ELF format.

ELF file header: The ELF file header is located at the beginning of the file and includes important information that describes the entire ELF file, such as file type, target system structure, entry point address, segment table, and flags.

Program segment: The program segment defines the layout of an executable file in memory. Each program segment describes the memory blocks required for executing the executable file, such as code segment, data segment, and stack segment. Each segment has its own attributes, such as location, size, access permissions, and so on.

Section table: The section table includes descriptions and attributes of all sections. It provides indexes and links to program segments, shared libraries, symbol tables, relocation tables, and other information. Each section further includes a flag field for labelling the attributes of the section.

The ELF format is extensible and flexible, and supports various types of object files, including executable files, shared libraries, object files, and core dump files.

### Executing an ELF Executable File

When an ELF executable file is executed, it needs to be mapped into the virtual address space of the virtual memory so that the processor can execute the instructions therein and access the data therein. This mapping process involves two major steps: page table mapping and demand paging.

### About Page Table Mapping:

Each process formed when an executable file is executed has its own virtual address space, and the space is usually divided into multiple pages or multiple segments. The size of each page or each segment is usually fixed, e.g., 4 KB.

The physical address space of the physical memory is divided into multiple page frames with a size that is the same as the size of a page or a segment. A page frame is a sequence of contiguous addresses of the physical memory and is usually of a fixed size, such as 4 KB.

A page table is a data structure used to map pages in a virtual address space to physical page frames. Each page table entry in a page table corresponds to a page in the virtual address space. Each page table entry includes information about the mapping relationship between the pages and the page frames, such as the starting address and the permissions of the corresponding page frame.

When an ELF executable file is loaded into memory, the operating system creates corresponding page table entries based on the structure and the information of sections of the ELF file, and maps the pages in the virtual address space to the physical page frames. In this way, instructions and data of the executable file can be accessed through virtual addresses.

### About Demand Paging:

When an ELF executable file is mapped to a virtual address space, not all pages are loaded into memory immediately. Instead, a page is read from a storage device such as a disk into the memory only when the contents of the page are accessed. This on-demand loading mechanism is known as demand paging.

Demand paging is usually implemented through a paging mechanism. When a process is executed to a page that is not yet loaded into memory, the processor triggers a page fault interrupt. Upon receiving this interrupt, the operating system reads the page from the storage device into a free page frame, and then updates the corresponding page table entry to point the mapping of the page to the new page frame.

The advantage of demand paging is saving memory space because the contents of a page are loaded only when needed. Demand paging also allows more executable files to be loaded into virtual address space, such that the size of the virtual address spaces of the processes of these executable files can exceed that of the available physical memory.

In summary, when an ELF executable file is being executed, it is mapped into the virtual address space of the process of that executable file. This mapping involves the mechanisms of page table mapping and demand paging. Page table mapping maps the pages in the virtual address space to the page frames of the physical memory, while demand paging loads the contents of the pages into memory on demand to save memory space and allow more contents of executable files to be loaded into virtual address space.

### Page Cache

In the Linux kernel, page cache is a mechanism for temporarily storing pages read from the file system. It provides a page-based caching system to speed up read and write operations on files. The main features of the page cache are as follows.

Firstly, page-based caching: The page cache performs page-based caching, which means the pages are units of the caching, and the size of the pages is usually 4 KB. When a file is read, the relevant pages will be read from a storage device such as a hard disk into the page cache. When data is written into a file, the relevant pages will be temporarily stored in the page cache and then written back into the storage device.

Secondly, fast reading: If a page in a file already exists in the page cache, when it is necessary to read the page, it can be read directly from the page cache without accessing the storage device, thus improving the efficiency of reading.

Thirdly, delayed writing: When data is written into a file, the relevant pages are first written into the page cache instead of being written into the storage device immediately. This strategy of delayed writing can merge multiple scattered write operations and then perform them together, thus improving the efficiency of writing.

Fourthly, prefetch: The page cache can prefetch pages in the file into the page cache according to a prediction algorithm, in order to load the pages that may be needed in advance, so as to minimize the latency of subsequent read operations.

Fifthly, sharing: The page cache is shareable, that is, multiple processes opening the same file can share the same page in the page cache. This can save memory and increase the efficiency of file sharing and collaboration.

The page cache plays an important role in Linux by providing a page-based caching mechanism that accelerates read and write operations on files. The page cache not only provides efficient reading capability, but also optimizes writing performance through strategies such as delayed writing. With the sharing feature, multiple processes can share pages in the page cache to improve the efficiency of file sharing and collaboration.

### Virtual File System in Linux

Linux divides the file system into two layers, namely, the virtual file system (VFS) and the physical file system.

The Linux operating system supports a variety of physical file systems, such as the common ext2, ext3, ext4, xfs, and zfs file systems.

The virtual file system belongs to the software layer of the Linux kernel, and is a software abstraction layer that is implemented on top of the physical file system, and is configured to receive system calls related to the file system and to forward the system calls to the system interface implemented by the physical file system. The virtual file system of Linux includes important objects such as index nodes (inodes) and directory entries (dentries).

### File Structure of Linux

In the Linux kernel, a file structure (struct file) is a data structure representing an opened file. Each file structure in the kernel is used to manage an opened file and store various information about the file. Each file structure includes at least three pointers, namely, f_op, f_security and f_inode.

f_op is a pointer to the file operation structure of the file. The file operation structure includes pointers to functions related to various operations on the file, such as pointers to function for reading, writing, positioning, etc. With the f_op pointer, the Linux kernel can call appropriate functions to operate on the opened file.

f_security is a pointer to the security context used by the mandatory access control (MAC) module.

f_inode is a pointer to the inode of the file. The inode contains the metadata of the file, such as size and access permissions of the file.

File structures play a key role in the Linux kernel and allow the Linux kernel to track and manipulate information of the files such as open mode, current access position, and permissions.

### Task Structure of Linux

A task structure (task_struct) in the Linux kernel is a data structure representing a process or a thread, and is used to store basic information and status related to the process or the thread. The following is some of the uses and the functions of the task structure.

Thread management: Task structure is used to manage threads of Linux. Each task structure may store information related to status, priority, and scheduling attributes of a thread. Task structure allows the kernel to schedule and switch among threads in order to ensure fair and efficient execution.

Thread identification: Task structure includes fields such as process identification (pid) and thread group identification (tgid), which are used to uniquely identify each process or thread in the operating system. These IDs are used for thread management, as well as inter-thread communication and resource allocation.

Security context: A task structure includes a pointer to the security context of the process or the thread to which the task structure belongs. The security context is used by the Linux security module to record some states.

ptrace: The task structure includes a ptrace field, which is used to record the debugging information of a process or a thread.

### Linux Security Module

Linux Security Module (LSM) is a framework in the Linux kernel that supports a variety of computer security models. LSM provides the functionality required by MAC while minimizing modifications of the Linux kernel. This framework provides a mechanism for hooking multiple security checks into the Linux kernel.

LSM provides memory blocks known as security contexts for important objects in the Linux kernel, such as task structures and inodes, so that implementations of various security models can store their own information.

### Details of Embodiments

The implementation details of the protection method of the present disclosure is described below with reference to embodiments of the present disclosure.

The protection method of the present disclosure may be executed, by one or more processors of an electronic device, such as a computer, a server, or a network attached storage (NAS), in an operating system (e.g., Linux) of the electronic device.

Taking an ELF file as an example, first of all, a part of contents of the ELF file that needs to be protected may be encrypted by a utility application. The ELF file may be an executable file or a shared library. The encryption is usually done in the “.text” section where program instructions are stored, or in the “.strtab” section or the “.shstrtab” section where string literals are stored.

After a section of an ELF file is encrypted, a special label is set in the flag field of the section in the section table by the utility application to indicate that the section is encrypted.

When at least one section of an ELF file is encrypted, another special label is set in the header of the ELF file, e.g., in the flag field of the header, by the utility application, to indicate that the ELF file is encrypted and which algorithm has to be used to decrypt it.

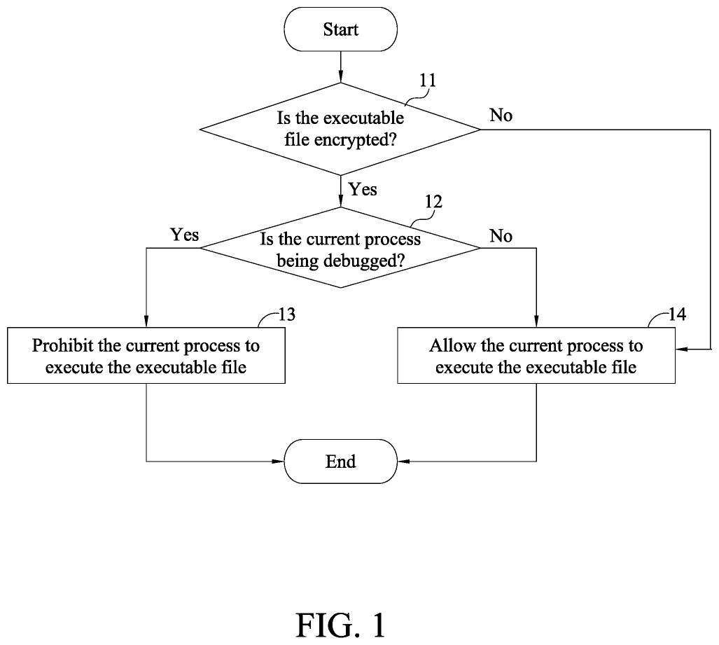

FIG. 1 to FIG. 3 are flowcharts of the protection method of an embodiment of the present disclosure. The present disclosure provides an MAC module in the kernel of an operating system to execute the flows shown in FIG. 1 to FIG. 3. In an embodiment, the electronic device determines whether a process is being debugged or whether the process is formed by the execution of an executable file in order to execute the flow shown in one of FIG. 1 to FIG. 3.

Whenever an executable file is about to be executed by a process that is in the running state (hereinafter referred to as the current process), the MAC module executes the flow in FIG. 1.

First, at step 11, the MAC module checks whether the executable file is encrypted. If the executable file is encrypted, the flow goes to step 12, otherwise the flow goes to step 14.

At step 12, check whether the current process is being debugged. If the current process is being debugged, the flow proceeds to step 13, otherwise the flow proceeds to step 14.

At step 13, the MAC module prohibits the current process to execute the executable file. Since the content of the executable file will be decrypted when it is executed, this prohibition can prevent the content of the executable file from being leaked during the debugging.

At step 14, the MAC module allows the current process to execute the executable file.

In addition, in step 14, the MAC module may parse the section table of the executable file to know the encrypted range of the executable file (i.e., which sections of the executable file are encrypted), and then record the encrypted range of the executable file in the security context of the file structure corresponding to the executable file.

Furthermore, in step 14, the MAC module may check whether the file structure of the executable file is linked to the page cache. If the file structure is linked to the page cache, the MAC module moves the executable file out of the page cache to prevent other processes from obtaining the decrypted contents of the executable file through the page cache.

Before executing an executable file, the executable file has to be mapped into the virtual address space of the process formed by the executable file. In addition, before a process executes a function in a shared library, it is necessary to map the shared library into the virtual address space of the process. The aforementioned two types of mapping may be referred to as memory mapping.

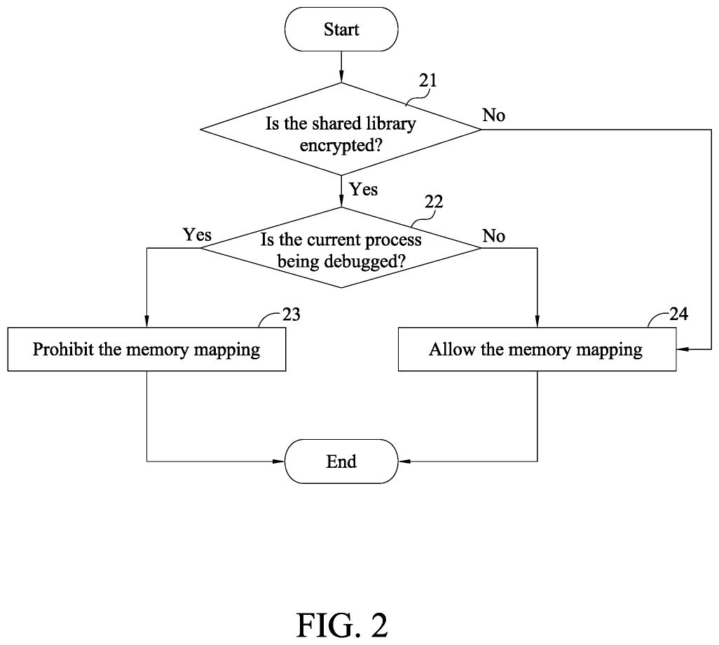

Whenever a process that is in the running state (hereinafter referred to as the current process) is about to perform memory mapping on a shared library, the MAC module executes the flow in FIG. 2.

First, at step 21, the MAC module checks whether the shared library is encrypted. If the shared library is encrypted, the flow goes to step 22, otherwise the flow goes to step 24.

At step 22, the MAC module checks whether the current process is being debugged. If the current process is being debugged, the flow goes to step 23, otherwise the flow goes to step 24.

At step 23, the MAC module prohibits the current process from performing the memory mapping on the shared library. Since the contents of the shared library will be decrypted during execution, this prohibition can avoid leaking the contents of the shared library during the debugging.

At step 24, the MAC module allows the current process to perform the memory mapping on the shared library.

In addition, in step 24, the MAC module may parse the section table of the shared library to know the encrypted range of the shared library (i.e., which sections of the shared library are encrypted), and then record the encrypted range of the shared library in the security context of the file structure corresponding to the shared library.

Furthermore, in step 24, the MAC module may check whether the file structure of the shared library is linked to the page cache. If the file structure is linked to the page cache, the MAC module moves the shared library out of the page cache to prevent other processes from obtaining the decrypted contents of the shared library through the page cache.

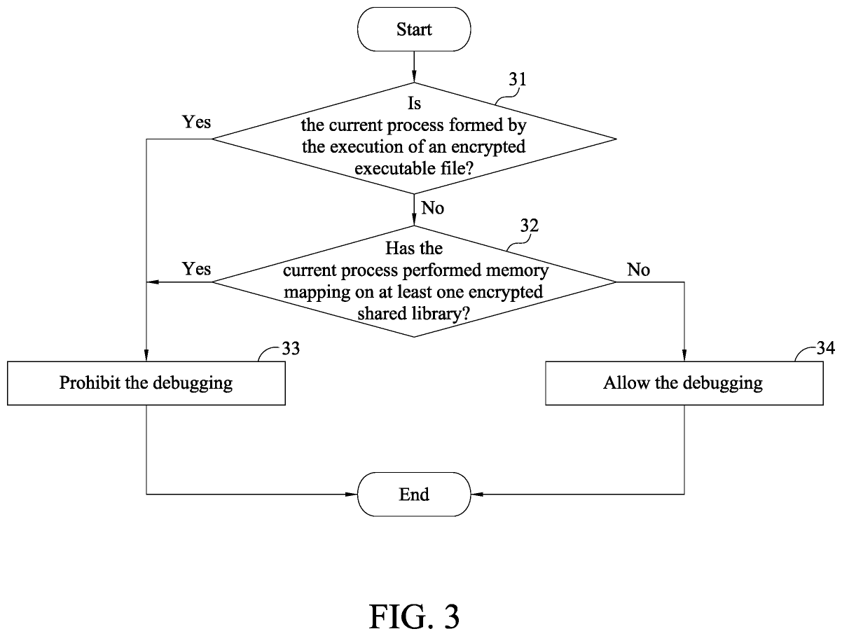

Whenever another process is about to debug the aforementioned current process, the MAC module performs the flow in FIG. 3.

For example, in the Linux operating system, the another process debugs the current process through the ptrace system call. Accordingly, the MAC module can perform MAC on the ptrace system call in the kernel of the operating system in order to process the ptrace system call pre-emptively according to the flow in FIG. 3.

First, at step 31, the MAC module checks whether the current process is formed by the execution of an executable file that is encrypted; if so, the flow proceeds to step 33; if not, the flow proceeds to step 32. For example, the MAC module may perform mandatory access control in the kernel of the operating system on the loading of the executable file. In addition, after the executable file of the current process is already loaded and before the current process is executed, the MAC module may check whether there is a label indicating encryption in the header of the executable file. If there is such a label, the MAC module may set a corresponding label in the security context of the task structure corresponding to the current process. Then, at step 31, the MAC module may check whether the corresponding label is set in the security context to determine whether the current process originates from an encrypted executable file.

At step 32, the MAC module checks whether the current process has performed memory mapping on at least one encrypted shared library; if so, the flow goes to step 33; if not, the flow goes to step 34. For example, the MAC module may perform mandatory access control on the memory mapping of the shared library in the kernel of the operating system. When a shared library is mapped to the virtual address space of the current process, the MAC module may check whether there is a label indicating encryption in the header of the shared library. If there is such a label, the MAC module may set a corresponding label in the security context of the task structure corresponding to the current process. Then, at step 32, the MAC module may check whether the corresponding label is set in the security context to determine whether the current process has performed memory mapping on an encrypted shared library.

At step 33, the MAC module prohibits the another process from debugging the current process to avoid leaking the contents of the executable file or the shared library that should be protected during debugging.

At step 34, the MAC module allows the another process to debug the current process.

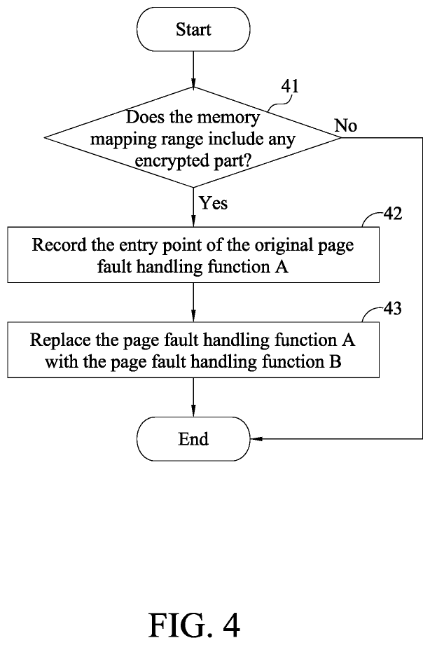

For the following descriptions, please refer to FIG. 4. After the operating system performs memory mapping on an ELF file (executable file or shared library), the MAC module may execute the flow in FIG. 4.

First, at step 41, the MAC module checks whether the memory mapping range of the ELF file includes any encrypted part of the ELF file. If the mapping range includes any encrypted part, the flow proceeds to step 42, otherwise the flow ends.

At step 42, the MAC module records the entry point of the original page fault handling function A of the operating system kernel provided by the file system containing the ELF file.

At step 43, the MAC module replaces the original page fault handling function A with the page fault handling function B provided by the MAC module.

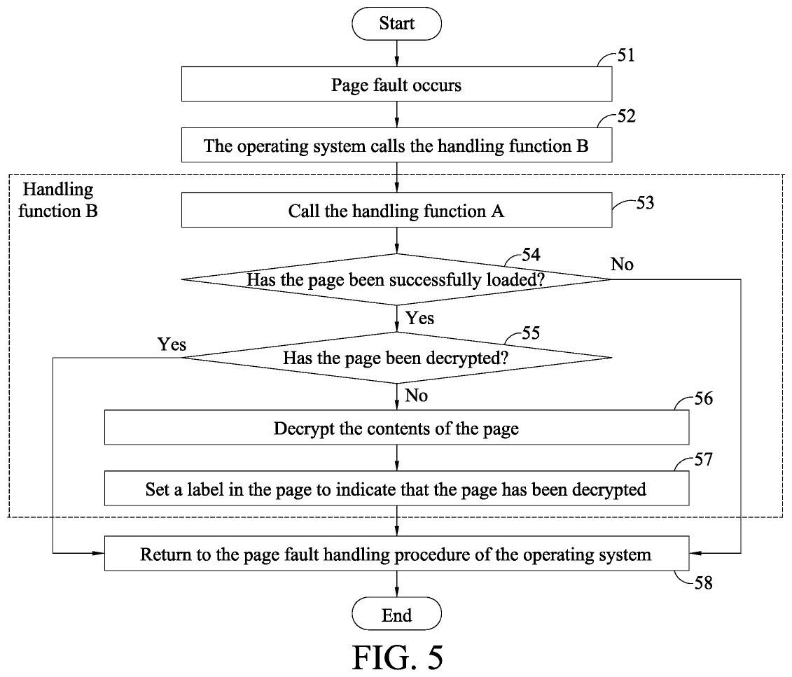

Please refer to FIG. 5 for the following descriptions. When a page fault occurs in a process that is in the running state, the MAC module may execute the flow in FIG. 5.

The flow in FIG. 5 is a continuation of the flow in FIG. 4, and is applicable to encrypted executable files and encrypted shared libraries stored in various types of file systems (e.g., ext2, ext3, ext4, zfs, xfs, etc.).

First, at step 51, a page fault occurs in the process.

At step 52, because of the page fault, the page fault handling procedure of the operating system calls the page fault handling function B. The subsequent steps 53-57 are performed by the page fault handling function B.

At step 53, the page fault handling function B calls the original page fault handling function A to instruct the page fault handling function A to load the contents of the page causing the page fault from the file system into the virtual address space of the process.

At step 54, the page fault handling function B checks whether the contents of the page have been successfully loaded into the virtual address space of the process. If the contents of the page have been loaded successfully, the flow proceeds to step 55, otherwise the flow proceeds to step 58.

At step 55, the page fault handling function B checks whether the contents of the page causing the page fault have been decrypted. If the contents of the page have been decrypted, the flow proceeds to step 58, otherwise the flow proceeds to step 56.

At step 56, the contents of the page are decrypted according to the decryption algorithm indicated in the header of the ELF file mapped to the page. In detail, only the encrypted range recorded in the security context of the file structure of the ELF file mapped to the page is decrypted. For example, the decryption algorithm transmits the contents of the page to the trusted platform module (TPM) in the electronic device for decryption. The TPM module is a hardware component that contains a key that can be used to encrypt and decrypt important data.

At step 57, the page fault handling function B sets a label in the page to indicate that the page has been decrypted.

At step 58, the flow of execution returns to the page fault handling procedure of the operating system.

Another embodiment illustrating the protection method of the present disclosure is set forth below. In an embodiment, the electronic device is a network attached storage (NAS), which is a type of network storage device that provides file sharing and storage services for a network. A NAS is usually a dedicated hardware device that contains one or more hard disk drivers and executes a specific operating system and vendor-specific software and firmware to provide functions such as file management, access control, and network communication. The operating system of a NAS is usually Linux.

In an embodiment, the image file of the operating system of the NAS (including the aforementioned MAC module), other kernel modules, and other software and firmware programs may be compiled into executable files and shared libraries by a compiler. Moreover, a utility application can be used to encrypt the “.text” section of an executable file or a shared library that needs to be protected. Whether to encrypt an executable file or a shared library may be determined according to whether the executable file or the shared library is vulnerable to network attacks. These executable files and shared libraries are ELF files and will continue to be ELF files after encryption.

When encrypting an ELF file, the utility application may set a certain bit in the flag field of the file header of the ELF file to 1 as the identification label indicating the decryption algorithm. For example, if the 31st bit of the flag field is set, it means the ELF file has to be decrypted by the Advanced Encryption Standard (AES) algorithm. If the 30th bit of the flag field is set, it means the ELF file has to be decrypted by the Data Encryption Standard (DES) algorithm. If the 29th bit of the flag field is set, it means that the ELF file has to be decrypted by the trusted platform module (TPM). In addition, the utility application may set a specific bit of the flag field of each encrypted section in the section table of the ELF file to 1 to be the identification label.

The aforementioned executable files and shared libraries of the NAS, after being encrypted by the utility application, may be packaged into an installation package for installing or updating the operating system, kernel modules, and other software and firmware of the NAS. After the installation or update is complete and the NAS is rebooted, the MAC module in the operating system of the NAS is executed before the encrypted ELF files.

In an embodiment, the NAS device includes a hardware TPM security chip that can store a key for decrypting the contents of ELF files when the ELF files are executed. The aforementioned encryption may be performed by another TPM chip or by the utility application using the same key. The encryption is performed in a secure software compilation and packaging environment to minimize the risk of key leakage.

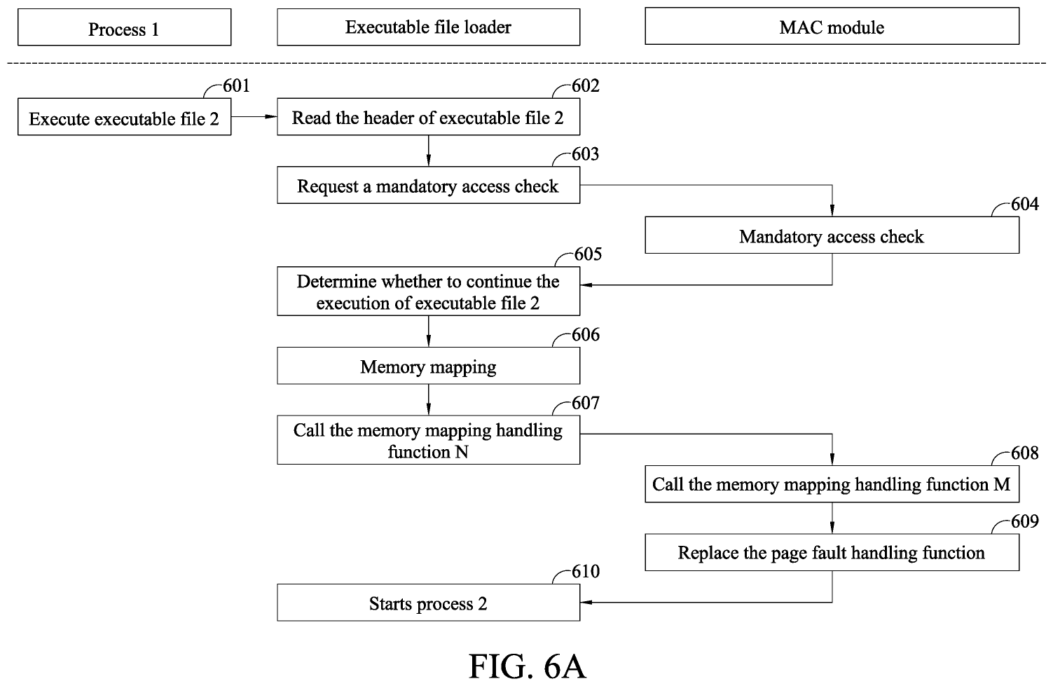

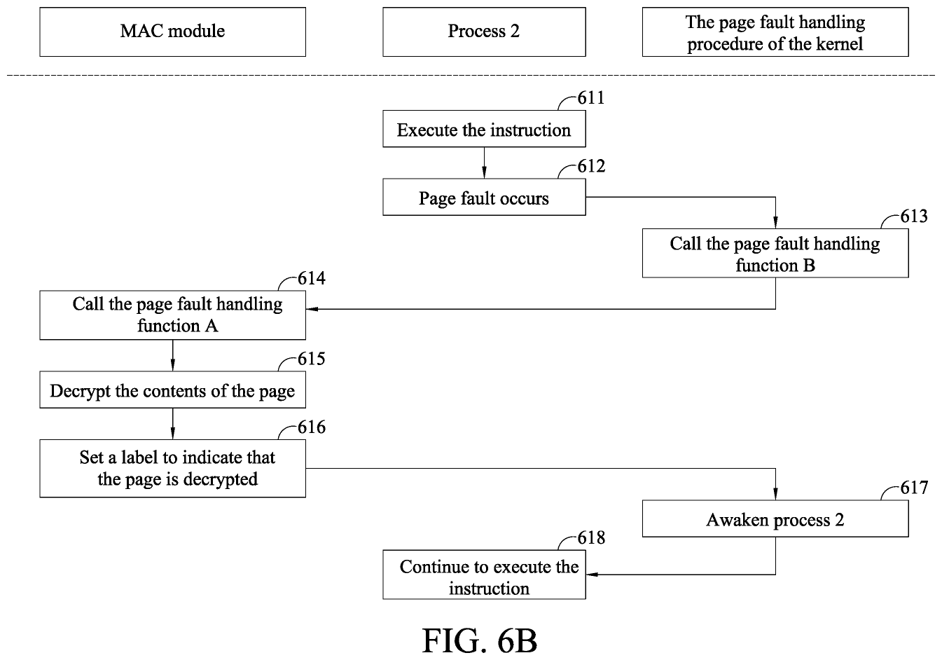

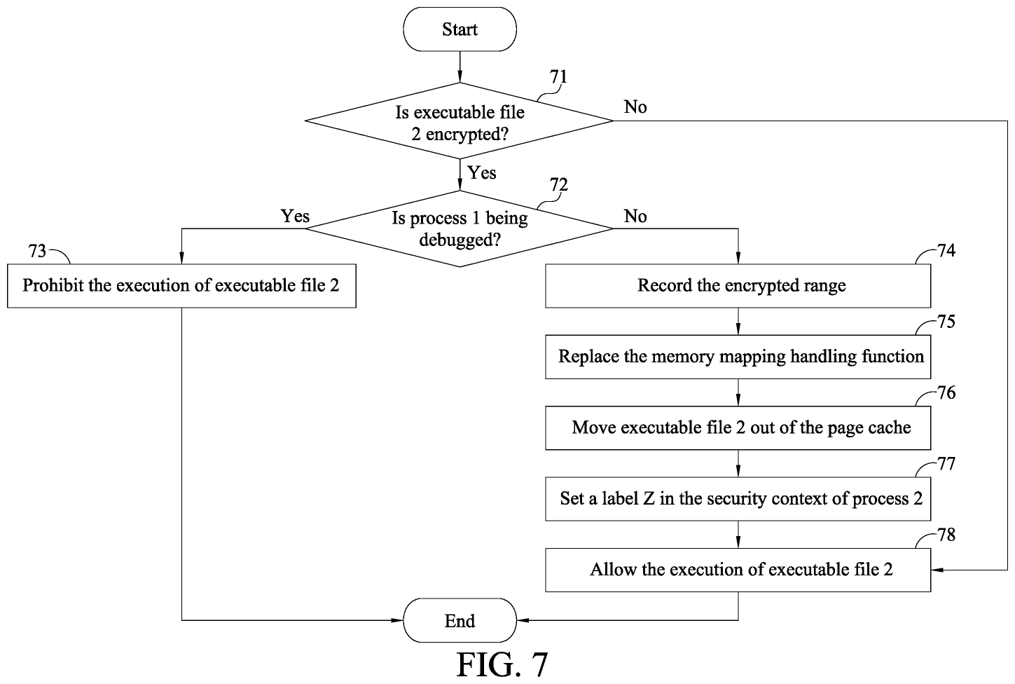

In one case, process 1 formed by executable file 1 in the NAS device determines to execute another executable file 2. FIG. 6A and FIG. 6B show the flowcharts of process 1 executing executable file 2. Please refer to FIG. 6A and FIG. 6B for the following descriptions.

First, at step 601, process 1 executes executable file 2. For example, process 1 may call a system call of Linux such as execve to execute executable file 2. The kernel of the Linux operating system can handle this system call.

At step 602, the executable file loader of the Linux kernel reads the header of executable file 2 to identify the format of executable file 2. In an embodiment, executable file 2 is in the ELF format, thus the ELF loader is used to load executable file 2.

At step 603, the ELF loader requests the MAC module of the Linux kernel to perform a mandatory access check.

At step 604, the MAC module performs the mandatory access check, whose flow is illustrated in FIG. 7, and the flow of the mandatory access check is described below by reference to FIG. 7.

At step 71, the MAC module first checks whether the 29th bit, the 30th bit or the 31st bit of the flag field of the file header of executable file 2 is set to 1 to determine whether executable file 2 is encrypted. If executable file 2 is encrypted, then the flow proceeds to step 72. Otherwise, if executable file 2 is not encrypted, the flow proceeds to step 78.

At step 72, the MAC module checks whether process 1 is being debugged. The MAC module may check the task structure of process 1 to determine whether process 1 is being debugged. If process 1 is being debugged, the flow proceeds to step 73. If process 1 is not being debugged, the flow proceeds to step 74.

At step 73, the MAC module returns a value indicating the prohibition of the execution of executable file 2 to the ELF loader.

In an embodiment, the 29th bit of the flag field of the file header of executable file 2 is set to 1, which indicates that executable file 2 is encrypted and should be decrypted by the TPM. In addition, process 1 is not being debugged, thus the flow proceeds to step 74.

At step 74, the MAC module reads the section table of executable file 2 to obtain the encrypted range of executable file 2 (i.e., which sections of executable file 2 are encrypted and must be decrypted), and then records the encrypted range in the security context pointed to by the file structure of executable file 2.

At step 75, the MAC module replaces the memory mapping handling function M recorded in the file structure of executable file 2 with the memory mapping handling function N provided by the MAC module.

Unless executable file 2 is opened in a special way, the read and write operations on executable file 2 are performed through the page cache of the Linux kernel. In order to prevent the contents of decrypted executable file 2 from leaking through the page cache, the MAC module moves executable file 2 out of the page cache at step 76.

At step 77, the MAC module sets a label Z in the security context pointed to by the task structure of process 2 generated by the execution of executable file 2 to indicate that process 2 originates from an encrypted executable file.

At step 78, the MAC module returns a value indicating the allowance of the execution of executable file 2 to the ELF loader.

Back to the flow depicted in FIG. 6A, at step 605, the ELF loader determines whether to continue the execution of executable file 2 according to the value returned by the MAC module. In an embodiment, the value returned by the MAC module allows the execution of executable file 2, thus the ELF loader continues to execute executable file 2.

At step 606, the ELF loader performs the memory mapping of executable file 2. In detail, the ELF loader maps the sections required to execute executable file 2 into the virtual address space of the virtual memory of process 2 generated by executable file 2. The ELF loader performs the memory mapping according to the aforementioned demand paging.

At step 607, the ELF loader calls the memory mapping handling function N. In an embodiment, the memory mapping handling function N is implemented in the MAC module.

At step 608, the memory mapping handling function N in the MAC module calls the original memory mapping handling function M.

At step 609, the memory mapping handling function N in the MAC module replaces the page fault handling function A provided to the Linux kernel by the file system containing executable file 2 with the page fault handling function B implemented in the MAC module.

At step 610, the ELF loader starts process 2 formed by the execution of executable file 2. The execution of process 2 is arranged to begin at the entry point recorded in the file header of executable file 2, and the entry point is located in the “.text” section of executable file 2. The steps of the subsequent flow are shown in FIG. 6B.

At step 611, the processor of the NAS fetches the instruction at the virtual memory address of the entry point to execute the instruction.

However, at step 612, a page fault occurs because the page corresponding to the virtual memory address of the entry point does not exist.

At step 613, the page fault handling procedure of the Linux kernel calls the page fault handling function B in the MAC module.

At step 614, the page fault handling function B first calls the original page fault handling function A. The page fault handling function A loads the contents of the page containing the instruction causing the page fault into the physical memory of the NAS to be fetched by the processor.

At step 615, the page fault handling function B checks whether the contents of the page are encrypted and are not decrypted yet. If the contents of the page are encrypted and are not decrypted yet, then the page is sent to the TPM of the NAS for decryption.

After the TPM finishes decrypting the page, at step 616, the page fault handling function B sets a label in the page to indicate that the page is decrypted to prevent the page from being decrypted repeatedly.

At step 617, the page fault handling procedure of the Linux kernel awakens process 2.

At step 618, since the page containing the instruction has already been loaded, the processor can continue to fetch and execute the instruction.

If process 3 of another debugger uses the ptrace system call to debug process 2, the kernel of the Linux operating system will call another function C of the MAC module to perform a mandatory access permission check when handling the system call. The function C will check whether the label Z has been set in the security context pointed to by the task structure corresponding to process 2, and will reject the debugging request of process 3 after finding that the label Z has been set in the security context.

The protection method of the present disclosure is not limited to the Linux operating system, but can also be applied to other operating systems that can support the technical solution of the protection method. In addition, the protection method of the present disclosure is not limited to protecting executable files and shared libraries in the ELF format, but can also be used to protect executable files and shared libraries in other formats that support the technical solution of the protection method.

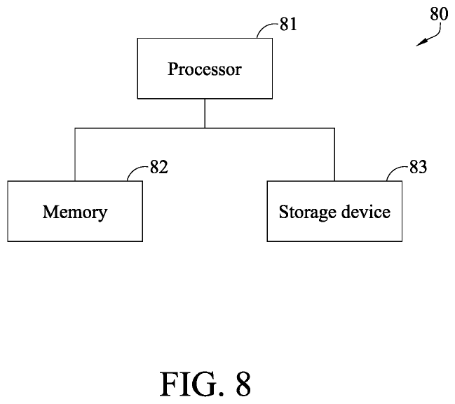

FIG. 8 is a block diagram of an electronic device 80 of an embodiment of the present disclosure. The electronic device 80 includes a processor 81, a memory 82 and a storage device 83 electrically connected to each other. The storage device 83 may include at least one data storage device, such as non-volatile memory or hard disk drive. There is an operating system, such as Linux, installed in the storage device 83. In addition, the storage device 83 is used for storing executable files and shared libraries in a file system. The processor 81 may be at least one processor that is used to execute the operating system and performs the protection method of any of the above embodiments in the operating system to prevent leakage of the contents of the executable files and the shared libraries. The memory 82 may be a volatile random-access memory that is used as the physical memory for the memory mapping of the executable files and the shared libraries. In addition, the memory 82 may be used to temporarily store the data required for the execution of the protection method and the data generated during the execution of the protection method.

In an embodiment, the present disclosure provides a computer-readable storage medium. The computer-readable storage medium may be a memory, a floppy disk, a hard disk, or an optical disk configured for storing a plurality of instructions that can be read by an electronic device to perform the protection method of any embodiment described above. For example, the computer-readable storage medium may be the storage device 83 in FIG. 8. The instructions may be the instructions in the aforementioned installation package. In addition, the instructions may be read by the processor 81 of the electronic device 80 to perform the protection method of any aforementioned embodiment. In another embodiment, the computer-readable storage medium is a non-transitory computer-readable storage medium.

In summary, the present disclosure protects executable files and shared libraries with techniques of anti-reverse engineering and anti-debugging to prevent attackers from obtaining decrypted contents in executable files and shared libraries through reverse engineering or debugging, and provides more stringent protection techniques to address at least one of the above shortcomings of prior art. In addition, the present disclosure is also applicable to executable files and shared libraries that have been processed through binary obfuscation.

While some of the embodiments of the present disclosure have been described in detail above, it is, however, possible for those of ordinary skill in the art to make various modifications and changes to the particular embodiments shown without substantially departing from the teaching and advantages of the present disclosure. Such modifications and changes are encompassed in the spirit and scope of the present disclosure as set forth in the appended claims.

What is claimed is:

1. A protection method for executable files and shared libraries, executed by at least one processor of an electronic device in an operating system of the electronic device, and the protection method comprising:
determining, by the electronic device, whether a first process is being debugged or is formed by execution of a second executable file;
if the first process is being debugged and is about to execute a first executable file that is encrypted, prohibiting the first process from executing the first executable file;
if the first process is being debugged and is about to perform memory mapping on a shared library that is encrypted, prohibiting the first process from performing the memory mapping on the shared library; and
if the first process is formed by the execution of the second executable file, the second executable file is encrypted, and a second process is about to debug the first process, prohibiting the second process from debugging the first process.

2. The protection method of claim 1, wherein after the first process performs the memory mapping on the shared library, the protection method further comprises:
if the shared library is encrypted and the second process is about to debug the first process, prohibiting the second process from debugging the first process.

3. The protection method of claim 1, further comprising:
determining, by the electronic device, whether the first executable file is encrypted according to a flag field of a header of the first executable file.

4. The protection method of claim 1, further comprising:
determining, by the electronic device, whether the shared library is encrypted according to a flag field of a header of the shared library.

5. The protection method of claim 1, wherein if the first process is formed by the execution of the second executable file, the protection method further comprises:
when executing the second executable file, determining whether the second executable file is encrypted according to a flag field of a header of the second executable file;
if the second executable file is determined to be encrypted, setting a label in a security context pointed to by a task structure of the first process;
when the second process is about to perform the debugging of the first process, checking whether the label has been set in the security context of the first process; and
if the label has been set in the security context, prohibiting the second process from performing the debugging of the first process.

6. The protection method of claim 1, wherein if the first process is formed by the execution of the second executable file and the second executable file is encrypted, the protection method further comprises:
replacing, by the electronic device, a first memory mapping handling function recorded in a file structure of the second executable file with a second memory mapping handling function, wherein the second memory mapping handling function comprises:
calling, by the electronic device, the first memory mapping handling function; and
replacing, by the electronic device, a first page fault handling function provided by a file system containing the second executable file with a second page fault handling function.

7. The protection method of claim 6, wherein the second page fault handling function comprises:
calling, by the electronic device, the first page fault handling function to load a page causing page fault of the first process from the file system into a virtual address space of the first process;
checking, by the electronic device, whether contents of the page have been decrypted; and
decrypting, by the electronic device, the contents of the page if the contents of the page have not been decrypted.

8. The protection method of claim 7, further comprising:
if the contents of the page have not been decrypted, using, by the electronic device, a decryption algorithm indicated in a flag field of a header of the second executable file to decrypt the contents of the page.

9. The protection method of claim 1, further comprising:
if the first executable file is encrypted and the first process is allowed to execute the first executable file, moving, by the electronic device, the first executable file out of a page cache of the operating system; and
if the shared library is encrypted and the first process is allowed to perform the memory mapping on the shared library, moving, by the electronic device, the shared library out of the page cache.

10. A protection system for executable files and shared libraries, comprising:
a storage device where an operating system is installed; and
at least one processor configured for executing the operating system and executing the protection method of claim 1 in the operating system.
